(19) United States
(12) Patent Application Publication
(10) Pub. No.: US 2025/0261758 A1
(43) Pub. Date: Aug. 21, 2025

(54) AIR PRESSURE ROD OF BUILT-IN MOTOR TYPE

(71) Applicant: Changzhou Weien Technology Development Co., Ltd, Changzhou (CN)

(72) Inventors: Zhiwen TAO, Changzhou (CN); Xiaogang LI, Changzhou (CN)

(73) Assignee: Changzhou Weien Technology Development Co., Ltd, Changzhou (CN)

(21) Appl. No.: 19/019,579

(22) Filed: Jan. 14, 2025

(30) Foreign Application Priority Data
Feb. 20, 2024 (CN) 202420308404.6

(51) Int. Cl. A47C 3/30; F16F 9/02

(52) U.S. Cl. CPC A47C 3/30; F16F 9/02

(57) ABSTRACT

An air pressure rod of built-in motor type includes lifting rod, gas spring, driving unit, and casing tube. Lifting rod includes outer tube of lifting rod and inner tube of lifting rod, wherein outer tube of lifting rod can move along the axial direction of the inner tube of lifting rod. Gas spring is arranged inside lifting rod and includes thread tube with thread on inner wall, piston and piston rod. Driving unit is fixedly arranged in outer tube of lifting rod and serves to drive piston rod in rotation so that piston rod drives outer tube of lifting rod to move along the axial direction of the inner tube of lifting rod. Casing tube is sleeved on outer side of lifting rod. In the present air pressure rod of built-in motor type, motor drives piston rod to rotate, thereby making rise or fall of the air pressure rod possible.

### CROSS REFERENCE TO THE RELATED APPLICATIONS

This application is based upon and claims priority to Chinese Patent Application No. 202420308404.6, filed on Feb. 20, 2024, the entire contents of which are incorporated herein by reference.

### TECHNICAL FIELD

The present invention relates to the technical field of air pressure rod, especially to the air pressure rod of built-in motor type.

### BACKGROUND

The lifting chair is a new type of chair which mainly consists of the seat plate, the backrest, the lifting device and the chair legs. It can meet the needs of different people regarding seat height. Existing lifting devices possess usually electric structure, pneumatic structure or manual structure. The lifting devices with manual structure are often laborious to operate and aesthetic performance is poor, which makes it difficult to meet people's increasing life requirements. The lifting devices with pneumatic structure are in general gas springs with a self-locking structure. This structure is beautiful, and the lifting process is relatively smooth. However, the lifting process requires manual operation, and this chair cannot bear too heavy load when climbing up manually. For example, in traditional lifting chairs, people must leave seat cushion on the chair before they can get up. When descending, they must sit on the chair to exert some load on seat cushion before descending, which makes the chair inconvenient to use. The lifting device of electric structure consists of the motor, the screw rod, the nut of the screw rod and the casing pipe in general. The device drives the screw rod by motor to ascent and descent in rotation. The entire lifting process is driven by motor, which ensures automatic ascent and descent are achieved. However, if the weight of the load from seat plates is greater, the engine power must also be increased accordingly. Volume and noise from the high-performance engine during operation increases, which negatively affects the user experience.

### SUMMARY

To solve problems existing in the prior art, the present invention proposes the air pressure rod of built-in motor type.

To achieve above-mentioned purpose, the present invention adopts the following technical solutions:

The air pressure rod of built-in motor type, including
lifting rod, which includes outer tube of lifting rod and inner tube of lifting rod, wherein outer tube of the lifting rod can move along the axial direction of the inner tube of lifting rod,
gas spring, which is arranged inside lifting rod and includes thread tube with thread on inner wall, piston and the piston rod, wherein distance between thread tube as well as inner tube of lifting rod remains constant, wherein piston is located at free end of piston rod and in the rotary seat with the inner wall of thread tube, wherein seal guide assembly is provided between the piston rod and the thread tube,
driving unit, which is fixedly arranged in the outer tube of the lifting rod and serves to drive the piston rod in rotation so that the piston rod drives the outer tube of the lifting rod to move along the axial direction of the inner tube of the lifting rod, and
casing tube, which is sleeved on the outer side of the lifting rod, wherein first guide sleeve is arranged between the casing tube and the outer tube of the lifting rod.

Preferably, the inner wall of thread tube is provided with thread projection, wherein piston is provided with thread groove which matches the thread projection, and wherein there is no self-locking between the piston and the thread tube.

Preferably, outer wall of inner tube of lifting rod is provided with the first convex strips evenly distributed along its axis, wherein inner wall of inner tube of lifting rod is provided with first grooves evenly distributed along its axis, wherein
lower end of inner tube of lifting rod is provided with inner tube plug of the lifting rod, wherein second convex strip is provided on the side wall of the inner tube plug of the lifting rod, which is adapted to the first groove, wherein
second guide sleeve is provided between outer tube of the lifting rod and inner tube of the lifting rod, and wherein the second groove is provided on the inner wall of the second guide sleeve, which is adapted to the second convex strip.

Preferably, the back plug of thread tube is permanently installed at the end of thread tube, wherein back plug of thread tube is permanently connected to inner tube plug of lifting rod.

Preferably, one end of the inner tube plug of the lifting rod is provided with the connecting rod for back plug which is connected to the back plug of the thread tube, wherein the other end of the inner tube plug of the lifting rod is provided with positioning rod, wherein the end of the casing tube is fixedly provided with sealing plate, and wherein the end of the positioning rod penetrates sealing plate and is connected to sealing plate via retaining spring.

Preferably, the driving unit includes motor, gear box and controller, wherein output end of motor drives piston rod for rotation through gear box.

Preferably, output end of gear box is connected to piston rod via coupling, wherein area on piston rod between coupling and thread tube is covered with shock-absorbing pad.

Preferably, the seal guide assembly includes spacer sleeve, oil seal and rear upper sleeve, wherein oil seal is located between spacer sleeve and rear upper sleeve, and wherein the rear upper sleeve is fixedly connected to the end of thread tube.

Preferably, connecting end of casing tube and connecting end of outer tube of lifting rod both have the shape of truncated cone.

The beneficial effects of the present invention are as follows:

1. In the present air pressure rod of built-in motor type, motor drives piston rod to rotate, while piston and thread tube cooperate with each other to make outer tube of the lifting rod move along the axial direction of inner tube of lifting rod, thereby making the rise or fall of the air pressure rod possible. The piston rod itself forms gas spring with thread tube and piston, so that gas spring has a certain output force when the air pressure rod of built-in motor type is extended. It can reduce load on motor and increase thrust under same conditions as well. The motor power of the present device is lower than that of motor in traditional electric pushing rod, and battery can be used for power supply, which increases application range of the air pressure rod of built-in motor type. The motor is installed in outer tube of lifting rod, making the entire air pressure rod of built-in motor type compact, easy to install and beautiful in structure.

2. In the present air pressure rod of built-in motor type, thread tube, piston rod and piston form non-self-locking gas spring. By controlling rotation of the motor, rotation of thread tube can be limited, automatic locking and unlocking of gas spring can be realized and stability of gas spring can be improved.

### BRIEF DESCRIPTION OF THE DRAWINGS

FIG. 1 shows a schematic diagram of three-dimensional structure related to air pressure rod of built-in motor type of the present invention.

FIG. 2 shows a schematic diagram of the front view of the structure related to air pressure rod of built-in motor type of the present invention.

FIG. 3 shows a schematic cross-sectional view related to A-A section of FIG. 2 of the air pressure rod of built-in motor type of the present invention.

FIG. 4 shows a schematic diagram of the three-dimensional structure related to inner tube of the lifting rod of the air pressure rod of built-in motor type of the present invention.

FIG. 5 shows a schematic diagram of the three-dimensional structure related to piston of the air pressure rod of built-in motor type of the present invention.

FIG. 6 shows a schematic diagram of front view related to thread tube of the air pressure rod of built-in motor type of the present invention.

FIG. 7 shows a schematic cross-sectional view related to B-B section of the air pressure rod of built-in motor type of the present invention.

FIG. 8 shows a schematic diagram of the three-dimensional structure related to inner tube plug of lifting rod of the of the air pressure rod of built-in motor type of the present invention.

FIG. 9 shows a schematic diagram of the three-dimensional structure related to first guide sleeve of the air pressure rod of built-in motor type of the present invention.

FIG. 10 shows a schematic diagram of the three-dimensional structure related to second guide sleeve of the air pressure rod of built-in motor type of the present invention.

Among them: 1. Outer tube of lifting rod; 2. Casing tube; 3. Inner tube of lifting rod; 4. Motor; 5. Gear box; 6. Coupling; 7. Piston rod; 8. Piston; 9. Thread tube; 10. Shock-absorbing pad; 11. Rear upper sleeve; 12. Oil seal; 13. Spacer sleeve; 14. Back plug of thread tube; 15. Inner tube plug of lifting rod; 16. Plastic bearing; 17. Connecting rod for back plug; 18. First guide sleeve;

19. Upper sleeve for outer tube of lifting rod; 20. Second guide sleeve; 21. Retaining spring; 31. First convex strip; 32. First groove; 81. Thread groove; 91. Thread projection; 151. Second convex strip; 152. Positioning rod; 201. Second groove.

### DETAILED DESCRIPTION OF THE EMBODIMENTS

The technical solution in embodiments of present invention will be clearly and completely described below in combination with the attached drawings in embodiment of present invention. Obviously, the embodiments described are only part of the embodiments of the present invention, not all embodiments.

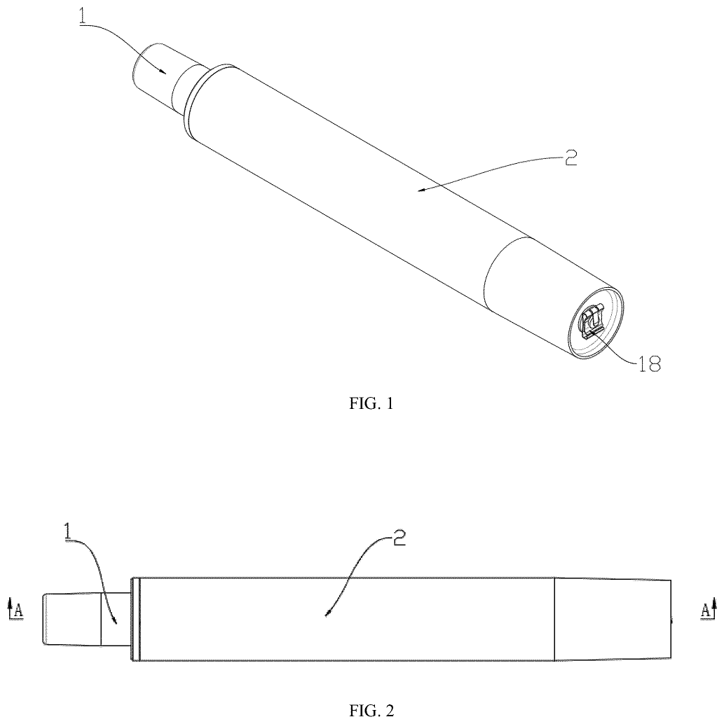

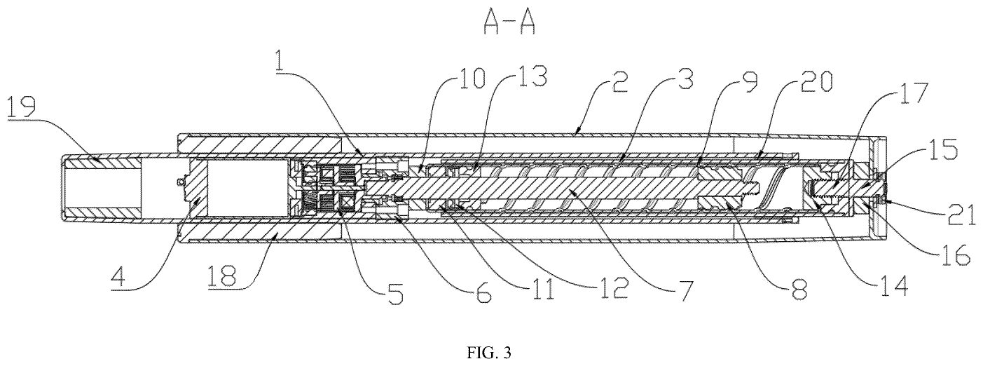

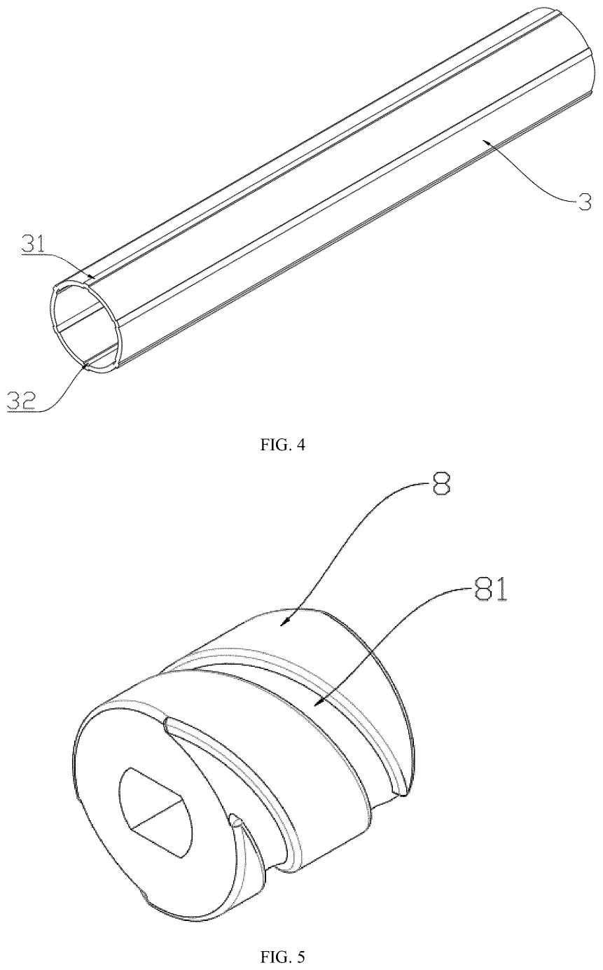

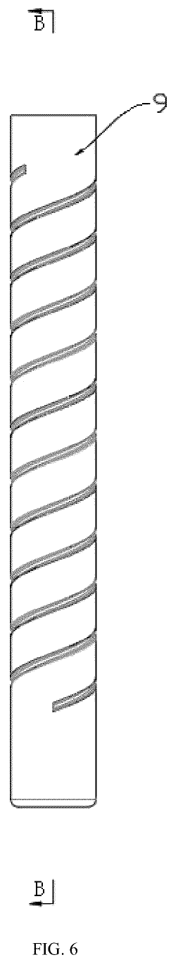

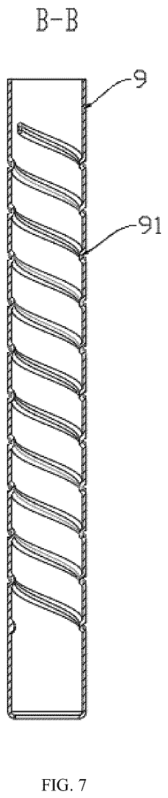

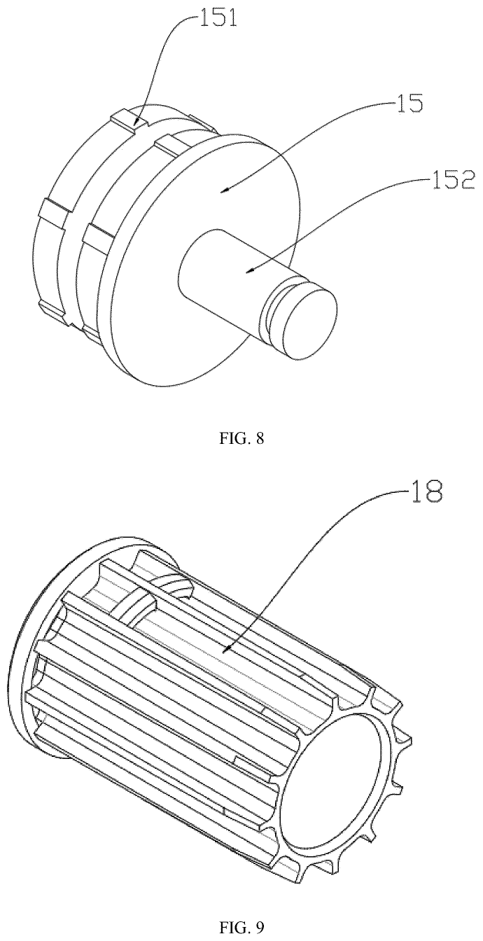

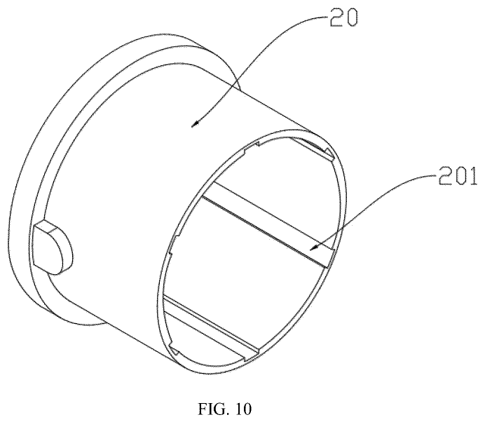

Referring to FIGS. 1 to 10, the air pressure rod of built-in motor type includes:
lifting rod, which includes outer tube of lifting rod 1 as well as inner tube of lifting rod 3, wherein outer tube of lifting rod 1 moves along axial direction of inner tube of lifting rod 3,
gas spring, which is arranged inside the lifting rod and includes thread tube 9 with thread on inner wall, piston 8 and the piston rod 7, wherein distance between thread tube 9 as well as inner tube of lifting rod 3 remains constant, wherein piston 8 is located at free end of piston rod 7 and in the rotary seat with the inner wall of thread tube 9, wherein seal guide assembly is provided between piston rod 7 and thread tube 9,
driving unit, which is fixedly arranged in outer tube of the lifting rod 1 and serves to drive piston rod 7 in rotation so that piston rod 7 drives the outer tube of lifting rod 1 to move along the axial direction of the inner tube of the lifting rod 3, and
casing tube 2, which is sleeved on outer side of the lifting rod, wherein first guide sleeve 18 is arranged between the casing tube 2 and outer tube of the lifting rod 1.

The inner wall of thread tube 9 is provided with thread projection 91, wherein piston 8 is provided with thread groove 81 which matches thread projection 91, and wherein there is no self-locking between piston 8 and thread tube 9.

Outer wall of inner tube of lifting rod 3 is provided with the first convex strips 31 evenly distributed along its axis, and inner wall of inner tube of lifting rod 3 is provided with first grooves 32 evenly distributed along its axis, wherein
lower end of inner tube of lifting rod 3 is provided with inner tube plug of lifting rod 15, wherein second convex strip 151 is provided on the side wall of inner tube plug of lifting rod 15, which is adapted to the first groove 32, wherein
second guide sleeve 20 is provided between outer tube of the lifting rod 1 and inner tube of the lifting rod 3, and wherein the second groove 201 is provided on the inner wall of the second guide sleeve 20, which is adapted to the second convex strip 151.

Back plug of thread tube 14 is permanently installed at the end of thread tube 9, wherein back plug of thread tube 14 is permanently connected to inner tube plug of lifting rod 15.

One end of inner tube plug of the lifting rod 15 is provided with connecting rod for back plug 17 which is connected to back plug of the thread tube 14, wherein the other end of inner tube plug of lifting rod 15 is provided with positioning rod 152, wherein the end of the casing tube 2 is fixedly provided with sealing plate, and wherein the end of positioning rod 152 penetrates sealing plate and is connected to sealing plate via retaining spring 21.

Plastic bearing 16 is installed between inner tube plug of lifting rod 15 and sealing plate.

Upper sleeve for outer tube of lifting rod 19 is fixedly installed at the top of the outer tube of lifting rod 1.

Driving unit includes motor 4, gear box 5 and controller. Output end of motor 4 drives piston rod 7 to rotate through the gear box 5. Gear box 5 is a planetary reduction gear box, and the controller is Hall encoder or other signal feedback unit. Output end of gear box 5 can be connected to end of piston rod 7 through coupling 6. The end of piston rod 7 can also be installed with double-ear back plug, which is connected to output shaft of gear box 5 through double-ear back plug and pin shaft.

Output end of gear box 5 is connected to piston rod 7 via coupling 6, wherein the area on piston rod 7 between coupling 6 and thread tube 9 is covered with shock-absorbing pad 10.

The seal guide assembly includes spacer sleeve 13, oil seal 12 and rear upper sleeve 11, wherein oil seal 12 is located between spacer sleeve 13 and rear upper sleeve 11, and wherein the rear upper sleeve 11 is fixedly connected to the end of thread tube 9.

Connecting end of casing tube 2 as well as connecting end of outer tube of lifting rod 1 both have the shape of truncated cone. That is, the ends of casing tube 2 and outer tube of lifting rod 1 are set at an angle, which is the same as the connection method of current conventional gas pressure rod with the taper fit.

In the present air pressure rod of built-in motor type, motor 4 drives piston rod 7 to rotate, while piston 8 and thread tube 9 cooperate with each other to make outer tube of the lifting rod 1 move along axial direction of inner tube of lifting rod 3, thereby making rise or fall of air pressure rod possible. The piston rod 7 forms gas spring with thread tube 9 and piston 8, so that gas spring has a certain output force when the air pressure rod of built-in motor type is extended. It can reduce load on motor 4 and increase thrust under same conditions as well. The motor power of the present device is lower than that of motor 4 in traditional electric pushing rod, and battery can be used for power supply, which increases application range of the air pressure rod of built-in motor type. The motor 4 is installed in outer tube of lifting rod 1, making entire air pressure rod of built-in motor type compact, easy to install and beautiful in structure.

2. In the present air pressure rod of built-in motor type, thread tube 9, piston rod 7 as well as piston 8 form non-self-locking gas spring. By controlling rotation of motor 4, rotation of thread tube 9 can be limited, automatic locking and unlocking of gas spring 4 can be realized and stability of gas spring can be improved.

The above content is only a preferred embodiment of the present invention. For ordinary technicians in the art, the changes are obtained based on the exemplary embodiment and applying scope according to the idea of the present invention, the content of the specification should not be understood as a limitation of the present invention. Any modifications, improvements, equivalent replacements and the like, made within the spirit as well as principle of the present invention, shall all be included in the protection scope of the present invention.

What is claimed is:

1. An air pressure rod of a built-in motor type, comprising
a lifting rod, wherein the lifting rod comprises an outer tube of the lifting rod and an inner tube of the lifting rod, and the outer tube of the lifting rod is configured to move along an axial direction of the inner tube of the lifting rod;
a gas spring, wherein the gas spring is arranged inside the lifting rod and comprises a thread tube with a thread on an inner wall, a piston and a piston rod; a distance between the thread tube and the inner tube of the lifting rod remains constant; the piston is located at a free end of the piston rod and in a rotary seat with the inner wall of the thread tube; and a seal guide assembly is provided between the piston rod and the thread tube;
a driving unit, wherein the driving unit is fixedly arranged in the outer tube of the lifting rod and serves to drive the piston rod in rotation so that the piston rod drives the outer tube of the lifting rod to move along the axial direction of the inner tube of the lifting rod; and
a casing tube, wherein the casing tube is sleeved on an outer side of the lifting rod, and a first guide sleeve is arranged between the casing tube and the outer tube of the lifting rod.

2. The air pressure rod of the built-in motor type according to claim 1, wherein the inner wall of the thread tube is provided with a thread projection, the piston is provided with a thread groove matching with the thread projection, and there is no self-locking between the piston and the thread tube.

3. The air pressure rod of the built-in motor type according to claim 2, wherein an outer wall of the inner tube of the lifting rod is provided with first convex strips evenly distributed along an axis of the inner tube of the lifting rod, and an inner wall of the inner tube of the lifting rod is provided with first grooves evenly distributed along the axis of the inner tube of the lifting rod;
a lower end of the inner tube of the lifting rod is provided with an inner tube plug of the lifting rod, and a second convex strip is provided on a side wall of the inner tube plug of the lifting rod and is adapted to the first grooves; and
a second guide sleeve is provided between the outer tube of the lifting rod and the inner tube of the lifting rod, and a second groove is provided on an inner wall of the second guide sleeve and is adapted to the second convex strip.

4. The air pressure rod of the built-in motor type according to claim 3, wherein a back plug of the thread tube is permanently installed at an end of the thread tube, and the back plug of the thread tube is permanently connected to the inner tube plug of the lifting rod.

5. The air pressure rod of the built-in motor type according to claim 4, wherein a first end of the inner tube plug of the lifting rod is provided with a connecting rod for the back plug, wherein the connecting rod is connected to the back plug of the thread tube; a second end of the inner tube plug of the lifting rod is provided with a positioning rod; an end of the casing tube is fixedly provided with a sealing plate; and an end of the positioning rod penetrates the sealing plate and is connected to the sealing plate via a retaining spring.

6. The air pressure rod of the built-in motor type according to claim 5, wherein the driving unit comprises a motor, a gear box and a controller, wherein an output end of the motor drives the piston rod for rotation through the gear box.

7. The air pressure rod of the built-in motor type according to claim 6, wherein an output end of the gear box is connected to the piston rod via a coupling, and an area on the piston rod between the coupling and the thread tube is covered with a shock-absorbing pad.

8. The air pressure rod of the built-in motor type according to claim 1, wherein the seal guide assembly comprises a spacer sleeve, an oil seal and a rear upper sleeve, wherein the oil seal is located between the spacer sleeve and the rear upper sleeve, and the rear upper sleeve is fixedly connected to an end of the thread tube.

9. The air pressure rod of the built-in motor type according to claim 8, wherein a connecting end of the casing tube and a connecting end of the outer tube of the lifting rod both have an shape of truncated cone.

10. The air pressure rod of the built-in motor type according to claim 2, wherein the seal guide assembly comprises a spacer sleeve, an oil seal and a rear upper sleeve, wherein the oil seal is located between the spacer sleeve and the rear upper sleeve, and the rear upper sleeve is fixedly connected to an end of the thread tube.

11. The air pressure rod of the built-in motor type according to claim 3, wherein the seal guide assembly comprises a spacer sleeve, an oil seal and a rear upper sleeve, wherein the oil seal is located between the spacer sleeve and the rear upper sleeve, and the rear upper sleeve is fixedly connected to an end of the thread tube.

12. The air pressure rod of the built-in motor type according to claim 4, wherein the seal guide assembly comprises a spacer sleeve, an oil seal and a rear upper sleeve, wherein the oil seal is located between the spacer sleeve and the rear upper sleeve, and the rear upper sleeve is fixedly connected to the end of the thread tube.

13. The air pressure rod of the built-in motor type according to claim 5, wherein the seal guide assembly comprises a spacer sleeve, an oil seal and a rear upper sleeve, wherein the oil seal is located between the spacer sleeve and the rear upper sleeve, and the rear upper sleeve is fixedly connected to the end of the thread tube.

14. The air pressure rod of the built-in motor type according to claim 6, wherein the seal guide assembly comprises a spacer sleeve, an oil seal and a rear upper sleeve, wherein the oil seal is located between the spacer sleeve and the rear upper sleeve, and the rear upper sleeve is fixedly connected to the end of the thread tube.

15. The air pressure rod of the built-in motor type according to claim 7, wherein the seal guide assembly comprises a spacer sleeve, an oil seal and a rear upper sleeve, wherein the oil seal is located between the spacer sleeve and the rear upper sleeve, and the rear upper sleeve is fixedly connected to the end of the thread tube.

16. The air pressure rod of the built-in motor type according to claim 10, wherein a connecting end of the casing tube and a connecting end of the outer tube of the lifting rod both have an shape of truncated cone.

17. The air pressure rod of the built-in motor type according to claim 11, wherein a connecting end of the casing tube and a connecting end of the outer tube of the lifting rod both have an shape of truncated cone.

18. The air pressure rod of the built-in motor type according to claim 12, wherein a connecting end of the casing tube and a connecting end of the outer tube of the lifting rod both have an shape of truncated cone.

19. The air pressure rod of the built-in motor type according to claim 13, wherein a connecting end of the casing tube and a connecting end of the outer tube of the lifting rod both have an shape of truncated cone.

20. The air pressure rod of the built-in motor type according to claim 14, wherein a connecting end of the casing tube and a connecting end of the outer tube of the lifting rod both have an shape of truncated cone.
